(19) United States
(12) Patent Application Publication
(10) Pub. No.: US 2009/0222107 A1
(43) Pub. Date: Sep. 3, 2009

(54) Modular safety switching system

(75) Inventors: Jorg Moddemann, Sexau (DE); Klaus Weddingfeld, Waldkirch (DE); Oliver Koepcke, Neuenburg (DE)

Correspondence Address: THE NATH LAW GROUP, 112 South West Street, Alexandria, VA, 22314, US

(73) Assignee: SICK AG, Waldkirch (DE)

(21) Appl. No.: 12/379,028

(22) Filed: Feb. 11, 2009

(30) Foreign Application Priority Data
Mar. 3, 2008 (EP) 08102223.8

(51) Int. Cl. G05B 11/01

(52) U.S. Cl. 700/21

(57) ABSTRACT

A modular safety device (10) is set forth for the safe deactivation of actuators (22, 24) which form a hazard source, said safety device having a control module (12) with a central safety controller (26), at least one connector module (14) of a first type with inputs for the connection of sensors (18, 20) and outputs for the connection of actuators (22, 24) as well as a serial communications device (28) for the exchange of data between the control module (12) and the connector module (14) based on a first communications protocol, in particular a bus. In this respect, at least one further connector module (16) of a second type is provided; the connector module (16) of the second type and the control module (12) are made for an exchange of data on the basis of a second communications protocol; and the safety controller (26) can exchange data alternatingly with the connector modules (14) of the first type in first time slots (38) over the first communications protocol and with the connector modules (16) of the second type in second time slots (40) over the second communications protocol.

The invention relates to a modular safety device and to a safety method for the safe deactivation of connected actuators forming a source of danger in accordance with the preambles of claims 1 and 7 respectively.

Safety switching devices serve to respond without error in a preset manner on the application of a danger signal. A safety device is a system having a safety controller and a connection for outputs which can be reliably deactivated. It can therefore be a safety switching device, but furthermore also generate different outputs than only switching outputs. A typical application of safety engineering is the securing of dangerous machinery such as presses or robots which have to be deactivated or secured immediately when an operator approaches in an unauthorized manner. A sensor which recognizes the approach is provided for this purpose, for instance a light grid or a safety camera. If such a sensor recognizes a hazard, a circuit downstream of it must generate a deactivation signal with absolute reliability.

In practice, a single sensor does not normally monitor a single machine, but rather a whole series of sources of danger have to be monitored. The corresponding high number of associated sensors which can each define a switching event and of suitable measures for the elimination of hazards then only has to be configured and wired in the safety switching device.

So that the safety switching device can be adapted flexibly for the very different conceivable configurations of sensors and actuators in industrial systems, it is known from DE 100 200 75 C2, for example, to form module series of input modules and output modules which therefore each have one or more inputs or one or more outputs. The module series can be expanded in dependence on the required number of inputs and outputs.

Control information is exchanged via serial communication, frequently a so-called backplane bus, by a central control unit which can itself be made as its own control module. For this purpose, the modules have control elements so that their inputs and outputs can take part in the data exchange of the bus communication.

The bus and the control elements of the individual modules are designed for a specific communications protocol. If now at a later time a change in the data transmission is required, for instance by new types of sensors with higher data traffic, this fixed communications protocol stands in the way of an expansion of the module series.

It would now be conceivable to equip the modules so that they can deal with a new, more powerful communications protocol. It is, however, actually not desired in safety engineering to change a functional system. Beyond the customary tests to ensure the operability after changing a technical system, it is namely also necessary in practice for a certification to take place, for instance by a state oversight office in accordance with a safety standard, so that the modules and the system may continue to be operated.

Alternatively, new modules could be inserted which master the new communications protocol. If, however, these new modules are connected to the existing bus, the old modules are confused by the data exchange by means of the new communications protocol; they lose their synchronization or misinterpret the signals which they attempt to receive using their unsuitable communications protocol. The module series is then no longer functional.

This alternative thus implies at least a conversion of the old modules up to a minimal understanding of the new communications protocol such that they can ignore communications on the basis of the new communications protocol. A new certification then has to take place as on a conversion to the complete new communications protocol. To prevent the conversion, the new modules could also be connected by means of redundant transmission physics, that is in particular by a second bus. However, this signifies a very substantial additional effort and/or cost.

Even if the additional effort and/or cost and the new certification is accepted, the system remains inflexible since the same problem which has just been described always arises again when the more powerful communications protocol is expanded or modified. Although the existing system therefore actually does not require any adaptation at all with respect to its partial tasks with the existing bus and the old modules, these old modules have to be converted with an effort and/or at a cost every time to maintain compatibility.

It is known, for example from computer or cell phone technology, to utilize a communications path multiply by time multiplexing. However, this method cannot be simply transferred to the described situation in safety switching devices because the old modules are not made for multiplexing. The conversion of the old modules to a multiplex method requires a comparable effort and/or cost to the conversion to the new communications protocol; strictly speaking, the possibility of multiplexing can also be understood as part of a communications protocol so that it is only a description of the same problem in different words.

It is therefore the object of the invention to introduce new possibilities for the exchange of data in a conventional safety switching system of the named kind without interfering in existing modules.

This object is satisfied by a modular safety switching device in accordance with claims 1 and 7 and by a safety switching method in accordance with claim 7.

In this respect, the solution in accordance with the invention starts from the principle of leaving the old modules, that is connector modules of the first type, unchanged at least with respect to the functions relevant to the serial communication or to the backplane, or even in total, and to insert new modules which are proficient in the second communications protocol, but which allow the existing serial communications device to be maintained with their communication.

The advantage results from this that the connector modules of the first type can continue to be used and above all do not have to be recertified. The safety switching device can be adapted flexibly to changes which require the introduction of a new communications protocol or its change, while the connector modules of the first type remain unchanged and do not even have to be removed from the existing installation. Two different communications protocols can be operated with maximum absence of reaction in time division multiplex using the existing transmission physics, i.e. the serial communications device. A conversion and adaptation of the total safety controller thereby becomes cost-effective, flexible and fast.

The connector module of the second type advantageously has a hardware actuator or a switch which can be switched by a control command and by means of which the connector module of the second type can alternatingly engage into the serial communications device in the first time slots and can connect to the control module in the second time slots. The connector module of the second type is thus equipped to carry out the required changes in the module series to establish the second communications protocol. If the connector module of the second type is engaged into the serial communications device, it is imaginable in a further development of the invention that the connector module of the second type simultaneously takes on the task of a connector module of the first type, that is it is also in particular capable of a data exchange by means of the first communications protocol.

The connector module of the second type is preferably made to switch its own communications to transparent in the first time slots, that is to forward data packets unchanged by means of the serial communications device and/or to interrupt the serial communications to downstream in the second time slots, that is in the opposite direction to that to the control module. The connector module of the second type thus allows the communication with the first communications protocol to pass without hindrance so that the established, tested and certified communication on the serial communications device remains. It is prevented in the second time slots by interruption of the communication to modules disposed downstream that the connector modules of the first type are confused by communication by means of the first communications protocol incomprehensible to them.

The second communications protocol advantageously enables a higher bandwidth than the first communications protocol and/or the time slots lie in time intervals which are not utilized by the first communications protocol. In this manner, connector modules and sensors and actuators connected thereto can be integrated which process and make available a larger data volume than those sensors and actuators for which the connector modules of the first type are designed. If the second time slots are placed into time intervals in which the connector modules of the first type anyway do not communicate, the bandwidth of the serial communications device does not lose anything and the communication over the first communications protocol can be continued in the same manner as if no connector modules of the second type were present.

The control module and the connector module are arranged in a housing which is in particular of the same type and has a respective plug and socket for the plugging into one another in an advantageous further development and the safety switching device forms a module series and/or the connector module of the second type is arranged between the control module and the connector module of the first type. The mechanical design by similar housings allows a uniform appearance and a simple conversion of the module series. The physical arrangement of the connector module of the second type directly next to the control module allows communication over short distances by means of the second communications protocol and the complete control over communication on the serial communications device disposed downstream.

In an advantageous further development of the invention, one or more further connector modules of a third type or of a further type are provided which have hardware actuators or switches which can be switched by a control command to communicate with the control modules in the second time slots by means of the second communications protocol or further communications protocols. The invention can therefore be generalized to a plurality of similar or different modules with one or more new communications protocols.

The method in accordance with the invention can be further developed in a similar manner and shows similar advantages. Such advantageous features are described in an exemplary, but not exclusive, manner in the dependent claims following the independent claims.

In a further development of the safety switching method for a module series with the connector module of the first type and with additional connector modules, namely the connector module of the second type and further connector modules of the second type, of a third type or of further types, the additional connector modules share the communication with the control module in the second time slots in accordance with one of the following schemes:
the additional connector modules utilize a part of the serial communications device as a separate serial communications device which connects all or part groups of the additional connector modules; and/or
each additional connector module has a respective second time slot assigned cyclically; and/or
all or part groups of the additional connector modules share a respective second time slot.

Depending on which data throughput an additional connector module requires and on how many additional connector modules the application demands, the communication thus becomes flexibly adapted to requirements.

In this respect, the additional connector modules particularly preferably communicate by means of the second communications protocol and/or by means of further communications protocols. A number of applications can be served satisfactorily by a further second communications protocol or by its expansions. The invention is furthermore also able to establish more than one additional communications protocol.

The invention will be explained in more detail in the following also with respect to further features and advantages by way of example with reference to embodiments and to the enclosed drawing. The Figures of the drawing show in:

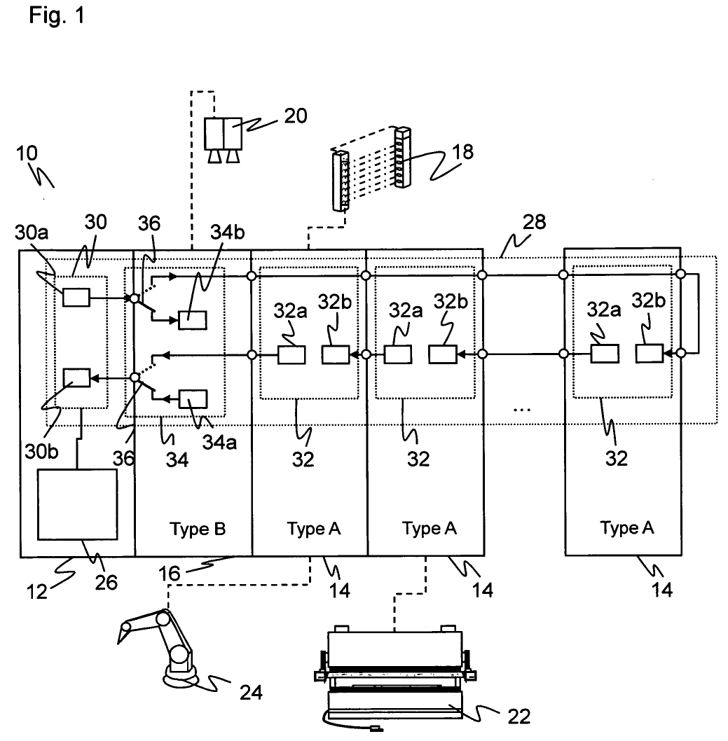

FIG. 1 the schematic representation of a first embodiment of a safety switching device in accordance with the invention;

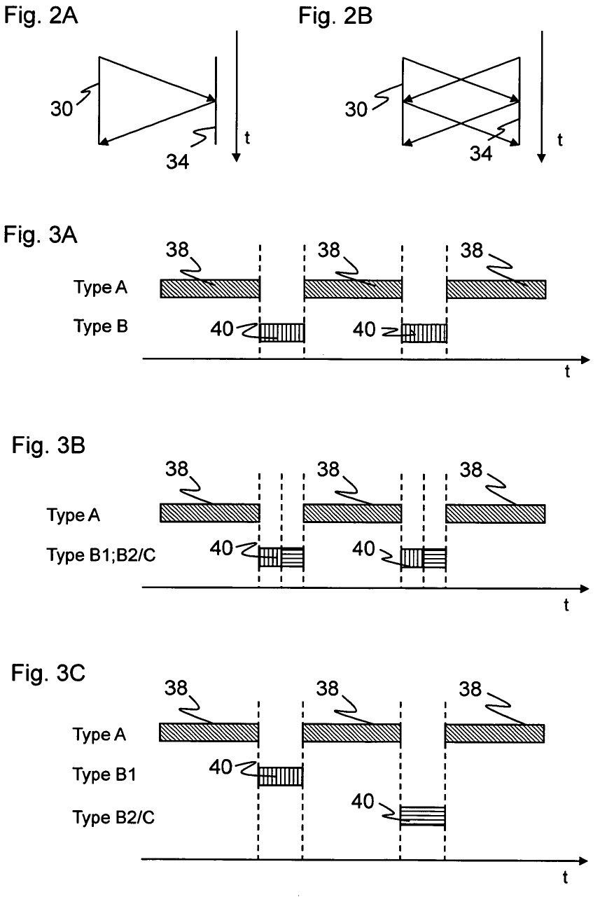

FIGS. 2a-b a schematic representation for the explanation of the different bandwidth on communication via a bus with respect to direct communication; and

FIGS. 3a-c different transmission schemes for the utilization of the second time sot with a plurality of similar or different types of additional connector modules.

FIG. 1 shows a first embodiment of a safety switching device 10 in accordance with the invention or of a safety device having a control module 12, a series of connector modules 14 of a first type A and a connector module 16 of a second type B. The connector modules 14, 16 each have inputs to sensors, here by way of example a light grid 18 and a three-dimensional safety camera 20, and outputs to actuators, in the example a press brake 22 and a robot 24 These sensors 18, 20 are able to recognize unauthorized intrusions into a protected zone, for instance by interruption of the light rays or deviations from a reference image, and to output a deactivation signal (OSSD, output switching signal device) which is output via the modules 12, 14, 16 to the actuators 22, 24 to deactivate a hazard source, for instance a dangerous machine 22 or a robot 24, or to put it into a safe state. It is conceivable to provided dedicated connector modules 14, 16 which each have only inputs or only outputs. Conversely, the control module 12 can also already have inputs and outputs and thus form the shortest conceivable module series.

Alternatively to a light grid 18 or to a 3D camera 20, further safety sensors of any desired kind, such as laser scanners, 2D cameras, safety shutdown mats or capacitive sensors, can be connected, but also other sensors, for instance for the taking of measurement data or simple switches such an emergency off switch. Further actuators than those shown are also conceivable, and indeed both those which generate a hazardous region and others, for instance a warning lamp, a siren, a display and the like.

The modules 12, 14, 16 each have similar housings and can be assembled to form a module series which forms the safety switching device 10 by means of plug connections which establish both an electrical and a mechanical connection.

A safety controller 26 in the control module 12 as a head of the module series receives data from the connected sensors 18, 20 conducts their deactivation signal onward or determines the deactivation or other activations of the actuators 22, 24 in accordance with a preset or configured logic. The safety controller 26 can be configured by means of an operating element or by means of software, for instance by a notebook, PDA or cell phone.

A communications bus which is marked by the reference numeral 28 as a whole is provided for the communication between the safety controller 26 of the control module 12 and the connector modules 14, 16. The bus 28 can be based on a field bus protocol such as CAN, Profibus or 10 link, or can be predicated thereon or can also have a proprietary standard.

So that the safety switching device 10 is secure, the inputs and/or outputs of the modules 14, 16, the safety controller 26 and the bus 28 are made failsafe by measures such as two-channel design, by diverse, redundant, self-checking or otherwise secure evaluations and self-tests. Corresponding safety demands for the control category are laid down in the standard EN 954-1 or ISO 13849 (performance level). The thus possible safety classification and the further safety demands on an application are defined in the standard EN 61508 and EN 62061.

The bus 28 is controlled by a bus master 30 of the control module 12. A plurality of participants 32 of the connector modules 14 of the type A (single-master, multiple slave communication) are associated with it. The bus master 30 in each case has a microcontroller for the transmission 30a and for the reception 30b; correspondingly, each participant 32 also has a microcontroller for the transmission 32a and for the reception 32b of data. The microcontrollers can be separate processors, FPGAs, ASICs, PLDs, DSPs or the like. Each module 14 of the type A takes data from the communication on the bus 28 in accordance with a communications protocol fixed for the communication with the controller module or applies data for other modules 14 or for the safety controller 26 to the bus 28 accordingly.

If a further module 14 of the type A is inserted into the module series, it becomes a further participant of the bus 28. In this respect, the safety controller 26 and the bus master 30 are designed for a maximum number of, for example, twelve connected modules 14, 16.

The connector module 16 of the type B which is physically arranged between the control module 12 and the connector module 14 of the type A and which is frequently, but not necessarily, inserted there in practice in the course of an expansion forms a special feature. The communications interface 34 of the connector module 16 of the type B is based on a different communications protocol than the bus 28. The connector module 16 of type B can, for example, be a gateway module which connects the control device 10 to a field bus and should therefore possibly transmit a particularly high amount of data, namely of the field bus, from and to the control module 12. In FIG. 1, an example is shown of a connector module 16 of the type B with a connected 3D camera 20 as a particularly complex sensor which has to process a greater data volume. Both are only examples for the requirement of a new communications protocol and it is equally conceivable to connect a 3D camera 20 to a connector module 14 of the type A, particularly since the data quantity to be processed by the sensor 20 does not necessarily correspond to that which the safety controller 26 reaches: The output of a binary deactivation signal as the only communication can be sufficient even for the integration of the 3D camera. Even though the new communications protocol is preferably higher performing or more powerful, that is substantially has a higher bandwidth, other reasons for the need of a new communications protocol are also conceivable, for example a larger number of participants or the adaptation to a previously unsupported sensor or actuator.

Like the connector modules 14 of the type A, the connector module 16 of the type B also has one respective or one common microcontroller for the transmission 34a and reception 34b of data. This microcontroller 34a, 34b, however, does not participate in the bus 28, but rather communicates directly and by means of its own new communications protocol with the bus master 30. The safety controller 26 and/or the bus master 30 must therefore also be able to exchange data on the basis of the new communications protocol.

The communication of the control module 12 with connector modules 14 of the type A via the bus 28 takes place alternatingly to a communication with connector modules 16 of the type B via the direct connection. For this purpose, actuators 36 are provided, that is switches made in hardware or software form, which can change between a position shown by a solid line in which the safety controller 25 communicates with the connector module 16 of the type B over the new communications protocol and a position shown by a dotted line in which the safety controller 26 communicates with the connector modules 14 of the type A and their communications protocol over the bus 28.

In the time slots in which the actuators 36 in the dashed position connect the bus 28 to the control module 12, the communications interface 34 is switched to transparent, that is it conducts data packets onward unchanged in both directions on the bus 28 without removing data. In the thus alternating time slots in which the actuators 36 in the solid position permit the direct communication with the control module 12, the transmission physics, that is the bus 28 to the connector modules 14 of the type A, is, in contrast, interrupted so that the participants 32 are excluded from the communication between the control module 12 and the connector module 16 of the type B and cannot attempt to remove or change the signals with their incompatible communications protocol and in this manner to set a connector module 14,16 into a non-defined state.

It is particularly elegant only to interrupt the communication with the bus 28 by means of the actuators 36 in those time intervals in which no data are anyway exchanged in accordance with the existing communications protocol, for example because this communications protocol makes provision to send data in intervals of 3 ms followed in each case by a pause of 1 ms.

In a further embodiment of the invention, a hybrid module can be provided which provides both the functionality of a module of the type A and that of a module of the type B. The hybrid module then decides whether it works as a module of the type B or not with reference to the position in the module series, namely whether only modules 14 of the type A are present or not downstream and whether only the control module 12 or modules 16 of the type B are present or not upstream. Another use possibility for such a hybrid module is that it satisfies both the role of a connector module of the type A and of a connector module of the type B, that is participates in the corresponding communications protocol in the communication taking place in the then current time slot in dependence on the position of the actuators 36.

The communication by means of the new protocol between the control module 12 and the connector module 16 of the type B can take place in the manner of a bus or directly. In the first case, a plurality of connector modules 16 of the type B can be integrated without problem; in return, each participant 34a, 34b or the bus master 30, as shown in FIG. 2a, can, however, only either transmit or receive per cycle. With direct communication, which can only take place with a single connector module 16 of the type B per time slot, each participant 34a, 34b or the bus master 30, as shown in FIG. 2b, transmits and receives simultaneously in each cycle and thus doubles the bandwidth. The application therefore decides which communication scheme is the best depending on whether the plurality of connector modules 16 of the type B or the bandwidth rather enjoys priority.

Different schemes for the division of the time slots for the communication to a specific module will now be explained with reference to FIGS. 3a-c. In FIG. 3, the communications scheme corresponds to the situation as has been explained in connection with FIG. 1. The connector modules 14 of the type A communicate via the bus 28 in first time slots 38 alternatingly to the connector module 16 of the type B in second time slots 40. In this respect, the first and second time slots can have constant lengths, and in particular the same length among one another, or the lengths are, as FIG. 3a shows, bound to lengths of the first time slots preset by the fixed protocol of the connector modules 14 of type A. The division into time slots shown in FIG. 3a is also valid for the situation in which a plurality of connector modules 16 of the type B operate the existing bus 28 in their time slots with the new communications protocol.

In FIG. 3b, an alternative situation is shown in which the bus master 30 communicates directly with a plurality of connector modules 16 of the type B, with only two connector modules 16 of the type B being shown, but further ones being conceivable. The actuators 36 then have further setting possibilities so that a change is made between the plurality of connector modules 16 of the type B within the time slot 40 available to the connector modules of the type B overall. This is only sensible if the overhead for the multiplexing still leaves sufficient bandwidth for the required data amount, that is the actual communication time does not become too short. Alternatively to a switchover between a plurality of connector modules 16 of the type B, connector modules of a further type C are conceivable which have their own communications protocol which then naturally also has to be proficient in the safety controller 26 and/or in the bus master 30.

FIG. 3c finally represents an alternative to the scheme of FIG. 3b in which the second time sots 40 are not split, but are rather assigned alternatingly. A single one of a plurality of connector modules 16 of the type B or of a further type C in accordance with an assignment scheme, for example a cyclic assignment scheme, can thus not exchange data for the communication by means of the new communications protocol in every time slot 40, but can in turn fully utilize those time slots 40 which are assigned so that the overhead is reduced.

1. A modular safety device (10) for the safe deactivation of actuators (22, 24) which form a hazard source, said safety device having a control module (12) with a central safety controller (26), at least one connector module (14) of a first type with inputs for the connection of sensors (18, 20) and/or outputs for the connection of actuators (22, 24) as well as a serial communications device (28) for the exchange of data between the control module (12) and the connector module (14) based on a first communications protocol, in particular a bus, characterized in that
at least one further connector module (16) of a second type is provided; in that the connector module (16) of the second type and the control module (12) are made for an exchange of data on the basis of a second communications protocol; and in that the safety controller (26) can exchange data alternately with the connector modules (14) of the first type in first time slots (38) over the first communications protocol and with the connector modules (16) of the second type in second time slots (40) over the second communications protocol.

2. A safety device (10) in accordance with claim 1, wherein the connector module (16) of the second type has a hardware actuator (36) or a switch which can be switched by a control command by means of which the connector module (16) of the second type can be integrated alternatingly into the serial communications device (28) in the first time slots (28) and can connect to the control module (12) in the second time slots (40).

3. A safety device (10) in accordance with claim 1, wherein the connector module (16) of the second type is made to switch its own communication to transparent in first time slots (38), that is to transfer data packets onward unchanged by means of the serial communications device (28), and/or to interrupt the serial communication (28) to connector modules (14) disposed downstream in second time slots (40), that is in the opposite direction to that to the control module (12).

4. A safety device (10) in accordance with claim 1, wherein the second communications protocol allows a higher bandwidth than the first communications protocol; and/or wherein the second time slots (40) lie in time intervals which are not utilized by the first communications protocol.

5. A safety device (10) in accordance with claim 1, wherein the control module (12) and the connector modules (14,16) are arranged in a housing, in particular a housing of the same type, having a respective plug and a respective socket for plugging into one another; and wherein the safety switching device (10) forms a module series; and/or wherein the connector module (16) of the second type is arranged between the control module (12) and the connector module (14) of the first type.

6. A safety device (10) in accordance with claim 1, wherein one or more further connector modules of a third type or of a further type are provided which have hardware actuators or switches which can be switched by a control command to communicate with the control module (12) by means of the second or further communications protocol in the second time slots (40).

7. A safety method for the safe deactivation of actuators (22, 24) forming a hazard source by means of a modular safety deactivation device (10), wherein a control module (12) of the safety switching device (10) exchanges data based on a first communications protocol with at least one connector module (14) of a first type by means of a serial communications device (28), in particular of a bus, characterized in that
the control module (12) alternatingly exchanges data with the connector modules (14) of the first type over the first communications protocol in first time slots (38) and with connector modules (16) of a second type over a second communications protocol, in particular of a higher bandwidth than the first communications protocol, in second time slots (40) which in particular remain unused by the first communications protocol.

8. A safety method in accordance with claim 7, wherein the connector module (16) of the second type is alternatingly integrated into the serial communications device (28) in the first time slots (38) and switches its own communication to transparent, that is forwards data packets unchanged on the serial communications device (28) and connects to the control module (12) in second time slots and in so doing interrupts the serial communications device (28) to downstream, that is in the opposite direction to that to the control module (12).

9. A safety method in accordance with claim 7 for a module series having the connector module (14) of the first type and having additional connector modules, namely the connector module (16) of the second type and further connector modules of the second type, of a third type or of further types, wherein the additional connector modules share the communication with the control module (12) in the second time slots (40) in accordance with one of the following schemes:
the additional connector modules utilize a part of the serial communications device (28) as a separate serial communications device which connects all or part groups of the additional connector modules; and/or
each additional connector module has a respective second time slot (40) assigned cyclically; and/or
all or part groups of the additional connector modules share a respective second time slot (40).

10. A safety method in accordance with claim 9, wherein the additional connector modules communicate by means of the second communications protocol and/or by means of further communications protocols.
